(19) United States
(12) Patent Application Publication
(10) Pub. No.: US 2007/0146596 A1
(43) Pub. Date: Jun. 28, 2007

(54) Birefringence element, method of manufacture thereof, liquid crystal device, and projection display apparatus

(75) Inventor: Takamichi Fujii, Kanagawa-ken (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Tokyo (JP)

(21) Appl. No.: 11/645,525

(22) Filed: Dec. 27, 2006

(30) Foreign Application Priority Data
Dec. 27, 2005 (JP) 2005-374516

(51) Int. Cl. G02F 1/1335

(52) U.S. Cl. 349/117

(57) ABSTRACT

A birefringence element is formed by at least one layer of inorganic dielectric film formed on a light transmissive base material by oblique vapor deposition. The at least one layer of inorganic dielectric film has a film structure constituted by a great number of columnar structures that extend in a direction inclined with respect to the surface of the light transmissive base material and a great number of apertures, which are formed between the columnar structures and extend substantially in the same direction as the columnar structures. The mean cross sectional area of the apertures of at least the topmost layer of the at least one layer of inorganic dielectric film is within a range of 10 to 7500 nm².

### BACKGROUND OF THE INVENTION

1. Field of the Invention

The present invention relates to a birefringence element formed by at least one layer of inorganic dielectric film formed on a light transmissive base material by oblique vapor deposition, and a method for manufacture thereof. The present invention also relates to a liquid crystal device and a projection type display apparatus equipped with the birefringence element.

2. Description of the Related Art

Liquid crystal devices are widely in use to perform display and the like. The basic structure of a liquid crystal device is constituted by a liquid crystal layer sandwiched between a pair of substrates having electrodes thereon. The orientation of liquid crystal molecules within the liquid crystal layer is changed between a state in which voltage is applied, and a state in which voltage is not applied. Phase contrast correcting elements (¼ wavelength phase correcting elements and the like) are provided in the liquid crystal devices, to correct for refraction properties of the liquid crystal molecules.

Conventionally, organic phase contrast correction elements had been widely used. However, the use of inorganic phase contrast correction elements has been proposed for use in liquid crystal devices for projection type display apparatuses, such as projectors, due to their superior heat resistance properties, light resistance properties, and chemical stability.

A birefringence element constituted by at least one layer of inorganic film formed by oblique vapor deposition on the surface of a light transmissive base material has been proposed as an inorganic phase contrast correction element. It is known that inorganic films formed by oblique vapor deposition have a film structure constituted by a great number of columnar structures, and that they exhibit birefringent properties with respect to light incident perpendicular thereto (refer to “Thin Film Retardation Plate by Oblique Deposition”, T. Motohiro and Y. Taga, Applied Optics, Vol. 28, No. 13, pp. 2466-2482, 1989).

U.S. Pat. No. 6,187,445 discloses that birefringence elements that utilize inorganic films are more susceptible to changes in humidity than organic birefringence elements. The humidity dependence of birefringence elements that utilize inorganic films formed by oblique vapor deposition is thought to be caused by the entrance and exit of water into and out from apertures of the inorganic films. Provision of protective films on birefringence elements to prevent evaporation of water occluded in the inorganic films has been proposed as a technique to improve the humidity dependence thereof.

According to the technique proposed in U.S. Pat. No. 6,187,445, it is necessary to provide the protective film to prevent evaporation of water occluded in the inorganic films. There is a possibility that the protective film may influence the optical properties of the element, such as the refraction properties and the light transmissivity thereof. In addition, an additional manufacturing step becomes necessary, and therefore the ease of manufacture decreases while the manufacturing cost increases.

In addition, it is necessary to form a protective film without any leaks when applying the technique disclosed in U.S. Pat. No. 6,187,445, because humidity dependence is influenced by the gas barrier properties of the protective film. However, it is not easy to form a leak free protective film on an inorganic film formed by oblique vapor deposition, which has a great number of apertures therein. If there are leaks in the protective film, water enters and exits through the leaks. In the case that the leaks are large, a sufficient improvement in humidity dependence cannot be obtained.

### SUMMARY OF THE INVENTION

The present invention has been developed in view of the foregoing circumstances. It is an object of the present invention to provide an inorganic birefringence element having favorable optical properties such as birefringent properties, transmissivity, and haze value, that enables improvement of humidity dependence at low cost without increasing the number of manufacturing steps. It is also an object of the present invention to provide a liquid crystal device and a projection type display apparatus that employ the birefringence element.

The present inventors performed committed investigation in order to achieve the above object, and discovered that the humidity dependence of inorganic films formed by oblique vapor deposition differed greatly depending on the sizes of the apertures thereof. As a result, the present inventors arrived at the conclusion that favorable improvements in humidity dependence could be achieved by defining the sizes of the apertures of inorganic films formed by oblique vapor deposition.

The birefringence element of the present invention comprises:

a light transmissive base material; and

at least one layer of inorganic dielectric film formed on the surface of the light transmissive base material by oblique vapor deposition; wherein:

the at least one layer of inorganic dielectric film has a film structure constituted by a great number of columnar structures that extend in a direction inclined with respect to the surface of the light transmissive base material and a great number of apertures, which are formed between the columnar structures and extend substantially in the same direction as the columnar structures; and

the mean cross sectional area of the apertures of at least the topmost layer of the at least one layer of inorganic dielectric film is within a range of 10 to 7500 nm².

The “topmost layer of the at least one layer of inorganic dielectric film” refers to the layer of inorganic dielectric film furthest from the light transmissive base material. In the case that there is only one layer of inorganic dielectric film, said layer of inorganic dielectric film is the topmost layer.

In oblique vapor deposition, the growth of the great number of columnar structures does not fluctuate greatly on the surface onto which inorganic film is deposited. Therefore, there are no great fluctuations in the sizes of the apertures formed in the inorganic film. In addition, the cross sectional areas of the apertures do not fluctuate greatly in the thickness direction of the inorganic film. The shapes of the apertures which are formed in the inorganic film are substantially triangular, substantially circular, and substantially oval, for example.

In the present specification, the “mean cross sectional area of the apertures” is obtained by: imaging the surface of the inorganic dielectric film with a scanning electron microscope; obtaining the areas of 10 arbitrary apertures within the image; and averaging the areas of the 10 apertures.

The birefringence element of the present invention can realize a reduction rate of retardation value of 30% or less, when left static in an environment with a temperature of 60° C. and a relative humidity of 90% for three days. An inorganic birefringence element that can achieve such humidity dependence is in itself novel.

Measurements of the retardation value prior to and following the birefringence element being left static in the above environment are performed with the same measuring conditions, such as the measuring light employed.

The retardation value Re is a value expressed by d·Δn. In the expression, d is the film thickness, and Δn is the birefringence. In a birefringence element having a single inorganic dielectric film, the thickness of the inorganic dielectric film is designated as d, and the birefringence is designated as Δn to determine the retardation value Re. In a birefringence element having a plurality of inorganic dielectric films, the total thickness of the inorganic dielectric films is designated as d, and the birefringence of the combined inorganic dielectric films is designated as Δn to determine the retardation value Re.

In the birefringence element of the present invention, the inorganic dielectric film may be constituted by at least one of: a metal oxide, a metal nitride, and a metal oxynitride; and the birefringence element may have a transmissivity of 75% or greater with respect to a reference frequency of light incident thereto, and a haze value of 1% or less.

In the present specification, the “reference wavelength” is defined as the central wavelength of light incident into the birefringence element. Although the central wavelength depends on the type of light source, the reference wavelength is 700 nm in the case that the incident light is red light, 546 nm in the case that the incident light is green light, and 430 nm in the case that the incident light is blue light, for example. The “haze value” is measured according to JIS (Japanese Industrial Standards) K7136.

In the birefringence element of the present invention, the optical axes of the columnar structures that constitute at least the topmost layer of the at least one layer of inorganic dielectric film may be inclined with respect to a line normal to the surface of the light transmissive base material at an angle greater than or equal to 0° and less than 50° (refer to angle β of FIG. 3).

At least the topmost layer of the at least one layer of inorganic dielectric film may be formed by oblique vapor deposition, with the oblique vapor deposition direction being inclined at an angle greater than or equal to 40° and less than 90° with respect to a line normal to the surface of the light transmissive base material, on which the film is formed. By forming the film with the oblique vapor deposition direction being within this range, the angle of the optical axes of the columnar structures can be made to be within the aforementioned range.

In the present specification, the “oblique vapor deposition direction” refers to the direction of a vapor deposition source when viewed from the surface onto which the at least one inorganic dielectric film is formed by oblique vapor deposition.

In the birefringence element of the present invention, at least the topmost layer of the at least one layer of inorganic dielectric film may be formed by oblique vapor deposition within an atmosphere having a degree of vacuum of 0.001 Pa or greater.

In the birefringence element of the present invention, at least the topmost layer of the at least one layer of inorganic dielectric film may be formed by oblique vapor deposition with the temperature of the base material being 200° C. or less.

The birefringence element of the present invention may further comprise a surface inorganic film formed on the surface of the light transmissive base material by vapor phase deposition. The method of vapor phase deposition is not particularly limited. Examples of vapor phase deposition methods include sputtering and CVD (Chemical Vapor Deposition).

In the case that the birefringence element of the present invention is to be employed in combination with a liquid crystal cell, comprising a liquid crystal layer, a pair of substrates which are provided facing each other to sandwich the liquid crystal layer therebetween, and electrodes for applying voltage to the liquid crystal layer, provided on the pair of substrates, the surface inorganic film may perform phase contrast correction on the birefringent properties of liquid crystal molecules, which are arranged in a substantially uniaxial orientation, and the at least one layer of the inorganic dielectric film may perform phase contrast correction on the birefringent properties of liquid crystal molecules, which are arranged in hybrid orientations.

The birefringence element of the present invention may further comprise an anti-reflection layer provided on the outermost surface of at least one of a light incident side and a light emitting side.

The liquid crystal device of the present invention comprises:

a liquid crystal cell comprising:
a liquid crystal layer;
a pair of substrates which are provided facing each other to sandwich the liquid crystal layer therebetween;
orienting films for defining the orientation of liquid crystal molecules within the liquid crystal layers when voltage is not applied thereto, formed on the pair of substrates; and
electrodes for applying voltage to the liquid crystal layer, provided on the pair of substrates; and

the birefringence element of the present invention, provided facing the liquid crystal cell.

a light source;

a light modulating apparatus comprising the liquid crystal device defined in claim 25, for modulating light emitted by the light source; and

a projecting optical system, for projecting the light modulated by the light modulating apparatus.

The projection type display apparatus of the present invention comprises:

a light source;

a light modulating apparatus comprising the liquid crystal device of the present invention, for modulating light emitted by the light source; and

a projecting optical system, for projecting the light modulated by the light modulating apparatus.

In the birefringence element of the present invention, the mean cross sectional area of the apertures of at least the topmost layer of the at least one layer of inorganic dielectric film is regulated to be within a range of 10 to 7500 nm².

According to the present invention having the above configuration, an inorganic birefringence element, which has favorable optical properties such as birefringent properties, transmissivity, and haze value, and that enables improvement of humidity dependence, can be provided at low cost without increasing the number of manufacturing steps.

According to the present invention, an inorganic birefringence element can be realized, in which the reduction rate of a retardation value is 30% or less, when left static in an environment with a temperature of 60° C. and a relative humidity of 90% for three days.

### BRIEF DESCRIPTION OF THE DRAWINGS

FIG. 1 is a sectional view of a birefringence element according to a first embodiment of the present invention, illustrating the layer structure thereof.

FIG. 2 is a sectional view illustrating the structure of a liquid crystal device according to an embodiment of the present invention.

FIG. 3 is a diagram that illustrates the optical axis of an inorganic film (optical axis of columnar structures) formed by oblique vapor deposition, and the relationship between the optical axis of the inorganic film and the orienting axes of orienting films.

FIGS. 4A and 4B are diagrams for explaining the relationship between apertures of inorganic films and humidity dependence.

FIG. 5 is a sectional view of a birefringence element according to a second embodiment of the present invention, illustrating the layer structure thereof.

FIG. 6 is a schematic diagram that illustrates the configuration of a projection type display apparatus according to an embodiment of the present invention.

FIGS. 7A and 7B are SEM photographs of an inorganic film obtained as Example 1.

### BEST MODE FOR CARRYING OUT THE INVENTION

### First Embodiment

A birefringence element 1 according to a first embodiment of the present invention and a liquid crystal device 40 comprising the birefringence element 1 will be described with reference to the accompanying drawings. The liquid crystal device 40 to be described in the first embodiment is a normally white TN mode transmissive liquid crystal device, which is in a light state when voltage is not applied thereto. The liquid crystal device 40 is to be employed as a light modulating device for modulating colored light of specific wavelength bands (one of red light, green light, and blue light), which is mounted in a projection type display apparatus such as a projector. The birefringence element 1 of the first embodiment can be favorably applied to a liquid crystal device for modulating blue light (light having a wavelength of 430 nm, for example), which is close to ultraviolet light that greatly influences optical systems.

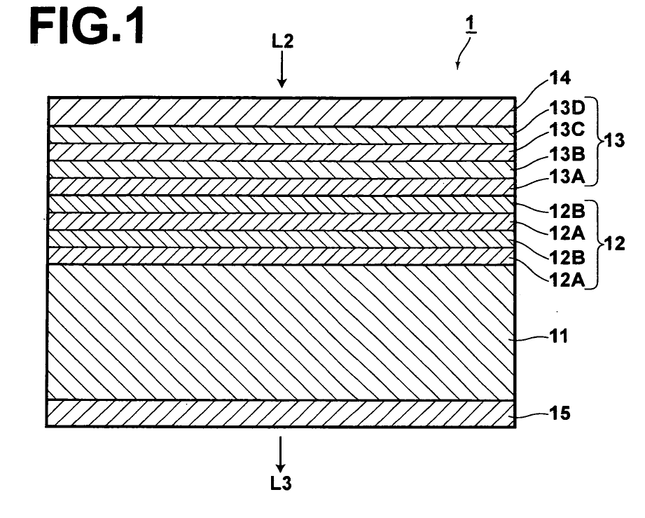

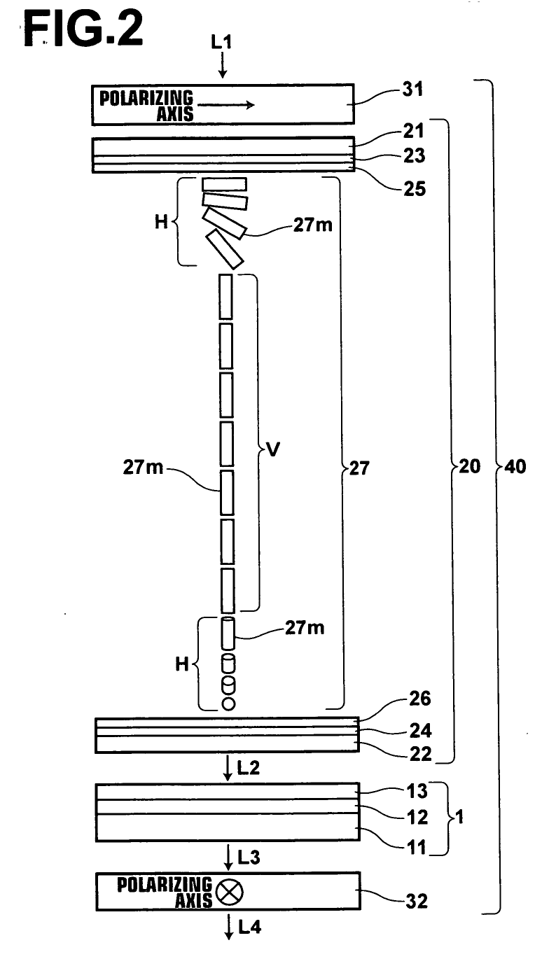

FIG. 1 is a sectional view of the birefringence element 1 illustrating the layer structure thereof. FIG. 2 is a schematic sectional view illustrating the structure of the liquid crystal device 40 (hatching is omitted from FIG. 2). In FIG. 1 and FIG. 2, the upper sides of the drawings are the light incident sides, and the lower sides of the drawings are the light emitting sides. In the FIG. 2, light emitted from a light source that enters a first polarizing element 31 is denoted by L1. In FIG. 1 and FIG. 2, light emitted from a liquid crystal cell 20 that enters the birefringence element 1 is denoted by L2, and light emitted from the birefringence element that enters a second polarizing element 32 is denoted by L3. In FIG. 2, light emitted from the second polarizing element 32 is denoted by L4.

As illustrated in FIG. 1, the birefringence element 1 of the first embodiment is a phase contrast correcting element, in which a first phase contrast correcting layer 12 and a second phase contrast correcting layer 13 are stacked on the surface of a light transmissive base material 11. The first phase contrast correcting layer 12 performs phase contrast correction on the birefringent properties of liquid crystal molecules, which are arranged in a substantially uniaxial orientation. The second phase contrast correcting layer 13 performs phase contrast correction on the birefringent properties of liquid crystal molecules, which are arranged in hybrid orientations.

The first phase contrast correcting layer 12 comprises a plurality of inorganic films 12A and 12B, which are formed by vapor phase deposition. The second phase contrast correcting layer 13 comprises a plurality of inorganic films 13A and 13B, which are formed by oblique vapor deposition.

Anti reflection layers 14 and 15 are formed on the surface of the second phase contrast correcting layer 13 and the light emitting surface of the light transmissive base material, respectively. That is, the anti reflection layers 14 and 15 are formed on the outermost surfaces of the light incident side and the light emitting side of the birefringence element 1, respectively.

As illustrated in FIG. 2, the birefringence element 1 of the first embodiment is utilized in the normally white TN mode transmissive liquid crystal device 40, which is in a light state when voltage is not applied thereto.

The liquid crystal device 40 has a liquid crystal cell 20 as a basic component thereof. The liquid crystal cell 30 comprises a liquid crystal layer 27 and a pair of substrates 21 and 22 (glass substrates or the like) which are provided facing each other to sandwich the liquid crystal layer therebetween. In the liquid crystal device 40, the substrate 21 is the substrate toward the light incident side, and the substrate 22 is the substrate toward the light emitting side. An electrode 23 and an orienting film 25 are formed on the inner surface of the substrate 21. Similarly, an electrode 24 and an orienting film 26 are formed on the inner surface of the substrate 22. Because the liquid crystal device 40 is of a TN mode, the orienting axes of the orienting films 25 and 26 are perpendicular with respect to each other. In FIG. 2, the orienting axis of the orienting film 25 extends in the horizontal direction, and the orienting axis of the orienting film 26 extends in a direction perpendicular to the drawing sheet.

The liquid crystal device 40 may be driven either by the passive matrix method or the active matrix method. The electrodes 23 and 24 are designed according to the driving method. For example, in the case that the active matrix driving method is adopted, one of the two electrodes 23 and 24 are constituted by a great number of pixel electrodes, while the other is constituted by a single common electrode.

The first polarizing element 31 is provided to face the light incident surface of the liquid crystal cell 20 (the outer surface of the substrate 21). The birefringence element 1 and the second polarizing element 32 are provided to face the light emitting surface of the liquid crystal cell 20 (the outer surface of the substrate 22). The first polarizing element 31, the liquid crystal cell 20, the birefringence element 1, and the second polarizing element 32 may be bonded together. Alternatively, the first polarizing element 31, the liquid crystal cell 20, the birefringence element 1, and the second polarizing element 32 may be provided as separate components, with narrow spaces therebetween.

The light L1 emitted from the light source enters the liquid crystal cell 20 via the first polarizing element 31. The light L2 emitted from the liquid crystal cell 20 enters the birefringence element 1. The light L3 emitted from the birefringence element 1 enters the second polarizing element 32. The light L4 is emitted from the second polarizing element 32 toward observers.

In the normally white mode, the first polarizing element 31 and the second polarizing element 32 are arranged in a crossed Nichol configuration, in which the polarizing axes thereof are perpendicular with respect to each other. The liquid crystal device 40 of the first embodiment is designed such that the polarizing axis of the first polarizing element 31 matches the orienting axis of the orienting film 21 and the polarizing axis of the second polarizing element 32 matches the orienting axis of the orienting film 22.

Liquid crystal molecules 27m within the liquid crystal layer 27 are in a twisted orientation (with a twist angle of 90°) when voltage is not applied, due to the regulations imposed by the orienting films 25 and 26. When voltage is applied, the orientation of the liquid crystal molecules 27m changes along a vertical electrical field generated between the electrodes 23 and 24, to become substantially vertically oriented (that is, oriented substantially uniaxially).

As described above, the liquid crystal molecules 27m within the liquid crystal layer 27 assume a substantially vertical (substantially uniaxial) orientation as a whole, when voltage is applied. However, in the vicinity of the orienting films 25 and 26, the liquid crystal molecules 27m may assume hybrid orientations, wherein the orientations thereof change gradually from substantially vertical to the orientations along the orienting axes of the orienting films 25 and 26.

FIG. 2 illustrates a state in which voltage is applied. A region where the liquid crystal molecules 27m are in the substantially vertical orientation is denoted by V, and regions where the liquid crystal molecules 27m are in hybrid orientations are denoted by H. Note that in FIG. 2, the orientations of the longitudinal axes of the liquid crystal molecules 27m in contact with the orienting films 25 and 26 are illustrated such that they match the orienting directions of the orienting films 25 and 26. In actuality, however, the orientation fluctuations of the liquid crystal molecules 27m within the hybrid orientation regions H are far less prominent than those illustrated in FIG. 2.

In the birefringence element 1 of the first embodiment, the first phase contrast correcting layer 12 performs phase contrast correction on the birefringent properties of the liquid crystal molecules 27m, which are arranged in a substantially uniaxial orientation when voltage is applied. The second phase contrast correcting layer 13 performs phase contrast correction on the birefringent properties of liquid crystal molecules 27m, which are in the vicinities of the orienting films 25 and 26 and are arranged in hybrid orientations with varying tilt angles when voltage is applied.

(Layer Structure of Birefringence Element 1)

Hereinafter, the layer structure of the birefringence element 1 will be described. The birefringence element 1 of the first embodiment is an inorganic birefringence element, and all of the components thereof are constituted by inorganic materials. The characteristic feature of the birefringence element 1 is the second phase contrast correcting layer 13.

<Light Transmissive Base Material>

The material of the light transmissive base material 11 is not particularly limited, and examples include: glass; sapphire; and crystal. The shape of the light transmissive base material 11 is not particularly limited, and a planar shape may be adopted. In the first embodiment, the light transmissive base material 11 is a separate component from the liquid crystal cell 20 and the polarizing element 32. Alternatively, a substrate of the liquid crystal cell 20 or the polarizing element 32 may be employed as the light transmissive base material 11.

<First Phase Contrast Correcting Layer>

The first phase contrast correcting layer 12 performs phase contrast correction on the birefringent properties of the liquid crystal molecules 27m (liquid crystal molecules 27m within the region V of FIG. 2), which are arranged in a substantially vertical orientation (substantially uniaxial orientation) when voltage is applied.

The first phase contrast correcting layer 12 exhibits negative uniaxial birefringent properties, and is a layer that exhibits the properties of a so-called negative C-plate. The first phase contrast correcting layer 12 is a multi-layer film, comprising high refractive index films 12A, having relatively high refractive indices, and low refractive index films 12B, having relatively low refractive indices, which are stacked alternately. Both the high refractive index films 12A and the low refractive index films 12B are inorganic films formed by vapor deposition (vapor phase epitaxial growth) of dielectric material in a direction substantially perpendicular with respect to the surface of the light transmissive base material 11. FIG. 1 illustrates an example in which two high refractive index films 12A and two low refractive index films 12B are alternately stacked on one another. However, the number of layers can be set as appropriate.

The optical film thickness, which is the product of the physical thickness and the refractive index, of both the high refractive index films 12A and the low refractive index films 12B is set to be within a range of 1/100 to ⅕ the reference wavelength λ of the light L2 which enters the birefringence element 1. Alternatively, the optical thickness may be within a range of 1/50 to ⅕ the reference wavelength λ of the light L2. As a further alternative, the optical thickness may be within a range of 1/30 to 1/10 the reference wavelength λ of the light L2.

The first phase contrast correcting layer 12 configured as described above does not exhibit birefringent properties with respect to light incident perpendicular thereto. This is because an electrical field generated thereby is solely constituted by waves (TE waves) that oscillate parallel to the planes of each layer of film. On the other hand, the first phase contrast correcting layer exhibits birefringent properties with respect to light incident at angles thereto. This is because an electrical field generated thereby is constituted by waves (TE wave components) that oscillate parallel to the planes of each layer of film, and waves (TM wave components) that oscillate perpendicular to the planes of each layer of film, and the effective refractive indices N_{TE} and N_{TM} differ for the TE wave components and the TM wave components. The birefringence Δn is derived from the film thickness and the refractive index of each of the high refractive index films 12A and each of the low refractive index films 12B. The birefringence Δn assumes a greater value the greater the difference between the refractive indices of the high refractive index films 12A and the low refractive index films 12B is (refer to Optics Vol. 27, No. 1 (1998), pp. 12-17).

The effective refractive indices N_{TE}, N_{TM} and the birefringence Δn are expressed by the following formulas.

$$\begin{matrix}{N}_{TE} = \sqrt{\frac{{an}_{1}^{2} + {bn}_{2}^{2}}{a + b}} \\ {N}_{TM} = \sqrt{\frac{a + b}{( a / {n}_{1}^{2} ) + ( b / {n}_{2}^{2} )}} \\ Δ n = {N}_{TM} - {N}_{TE}\end{matrix}$$

In the above formulas, n₁ and n₂ are the refractive indices, and a and b are the physical thicknesses of the high refractive index film 12A and the low refractive index film 12B, respectively.

That is, the retardation value Re=d·Δn of the first phase contrast correcting layer 12 is not particularly limited. Because the first phase contrast correcting layer 12 exhibits favorable phase contrast correcting functions, the formula listed below may be satisfied when the retardation value of the first phase contrast correcting layer 12 is designated as Re(0), and the retardation value of the liquid crystal layer 27 during maximum voltage application is designated as Re(LC).

The percentage of liquid crystal molecules 27m within the liquid crystal layer 27 that assume the substantially vertical orientation during maximum voltage application differs according to the type of liquid crystal, cell gap, the maximum voltage, and the like. For example, if the type of liquid crystal and the cell gap are the same, the percentage of liquid crystal molecules 27m that assume the substantially vertical orientation increases the greater the maximum voltage is, and the birefringence of the liquid crystal molecules 27m in the substantially vertical orientation increases.

The second phase contrast correcting layer 13 has positive birefringence, similar to the liquid crystal molecules 27m. Therefore, the second phase contrast correcting layer 13 also generates positive retardation in addition to the liquid crystal molecules 27m when voltage is applied. Accordingly, it is necessary to take the retardation value Re of the second phase contrast correcting layer 13 into consideration as well. For example, the thickness and the like of the first phase contrast correcting layer 12 may be determined according to the thickness and the like of the second phase contrast correcting layer 13.

The present inventors took the aforementioned points into consideration, and discovered that favorable phase contrast correcting function can be realized, by setting the retardation value Re(0) of the first phase contrast correcting layer 12 and the retardation value Re(LC) of the liquid crystal layer 27 during maximum voltage application such that they satisfy the following inequality (i).
−2Re(LC)≦Re(0)≦−0.5Re(LC) (i)

When calculating the retardation value Re(0)=d·Δn, d represents the film thickness of the entire first phase contrast correcting layer 12, and Δn represents the birefringence of the entirety thereof. Accordingly, the film thicknesses and refractive indices of each of the high refractive index films 12A and the low refractive index films 12B, and the film thickness d of the entire first phase contrast correcting layer 12 may be set so as to satisfy the above inequality (i).

The retardation value Re(LC) varies according to the wavelength of the light L1 that enters the liquid crystal device 40. Therefore, the retardation value Re(LC) may be obtained with respect to the reference wavelength λ of the light L1, and the retardation value Re(0) may be determined so as to satisfy the above inequality (i).

The materials that constitute the high refractive index films 12A and the low refractive index films 12B are not particularly limited. Taking ease of vapor deposition and light transmissivity into consideration, materials having relatively high refractive indices and materials having relatively low refractive indices may be selected from among: TiO₂ (2.2-2.4); ZrO₂ (2.20); SiO₂ (1.40-1.48); MgF₂ (1.39); CaF₂ (1.30); CeO₂ (2.45); SnO₂ (2.30); Ta₂O₅ (2.12); In₂O₃ (2.00); ZrTiO₄ (2.01); HfO₂ (1.91); Al₂O₃ (1.59-1.70); MgO (1.70); AlF₃; diamond thin film; LaTiOₓ; samarium oxide and the like. The high refractive index films 12A and the low refractive index films 12B may each be constituted by two or more of the above materials. The numbers in parentheses indicate the approximate refractive indices of each material.

Examples of combinations of materials for the high refractive index film 12A and the low refractive index film 12B include: TiO₂/SiO₂; Ta₂O₅/Al₂O₃; HfO₂/SiO₂; MgO/MgF₂; ZrTiO₄/Al₂O₃; CeO₂/CaF₂; ZrO₂/SiO₂; and ZrO₂/Al₂O₃.

<Second Phase Contrast Correcting Layer>

The second phase contrast correcting layer 13 performs phase contrast correction on the birefringent properties of the liquid crystal molecules 27m in the vicinities of the orienting films 25 and 26, which are influenced thereby and are arranged in hybrid orientations, wherein the orientations thereof change gradually from substantially vertical to the orientations along the orienting axes of the orienting films when voltage is applied.

The second phase contrast correcting layer 13 exhibits positive birefringence, and is a layer that exhibits the properties of a so-called O-plate.

The second phase contrast correcting layer 13 is a multi-layer film, comprising inorganic films 13A through 13D, which are formed by oblique vapor deposition. In the first embodiment, an example will be described in which the second phase contrast correcting layer 13 is constituted by four layers of inorganic film. However, the number of layers of inorganic film that constitute the second phase contrast correcting layer 13 may be set as appropriate.

Each of the inorganic films 13A through 13D is formed by vapor deposition of dielectric materials in a direction inclined with respect to the surface of the light transmissive base material 11. Each of the inorganic films 13A through 13D has a film structure constituted by a great number of columnar structures X that extend in a direction inclined with respect to the surface of the transmissive base material 11 and a great number of apertures Y, which are formed between the columnar structures and extend substantially in the same direction as the columnar structures, as illustrated in the schematic sectional views of FIGS. 4A and 4B.

FIGS. 4A and 4B illustrate a base material B and two types of inorganic films M1 and M2, formed on the base material B by oblique vapor deposition. The sizes of the columnar structures X and the apertures Y differ in the inorganic films M1 and M2.

The inorganic films 13A through 13D exhibit birefringent properties due to the structures thereof, constituted by the columnar structures X and the apertures Y. A refractive index nₒ with respect to ordinary light, a refractive index nₑ with respect to extraordinary light, and a split angle φ of polarized light beams are expressed by the following formulas.

$$\begin{matrix}{n}_{o} = {\{ \frac{( 1 - q ) {n}_{1}^{4} + ( 1 + q ) {n}_{1}^{2} {n}_{2}^{2}}{( 1 + q ) {n}_{1}^{2} ( 1 - q ) {n}_{2}^{2}} \}}^{\frac{1}{2}} \\ {n}_{e} = {\{ ( 1 - q ) {n}_{1}^{2} + {qn}_{2}^{2} \}}^{\frac{1}{2}} \\ ϕ = {tan}^{- 1} \frac{( {n}_{e}^{2} - {n}_{o}^{2} ) tan θ}{{n}_{e}^{2} + {n}_{o}^{2} {tan}^{2} θ}\end{matrix}$$

In the above formulas, n₁ is the refractive index of the apertures Y, n₂ is the refractive index of the columnar structures X, and q is the percentage of the film that the columnar structures X occupy (filling factor; q=1 when no apertures are present).

As shown in the above formulas, greater birefringence, and therefore phase contrast correcting functions, can be obtained by growing the columnar structures X from materials having comparatively large refractive indices such that the inorganic films 13A through 13D have an appropriate percentage of apertures.

In the section “Description of the Related Art”, it has been stated that inorganic films formed by oblique vapor deposition are more susceptible to changes in humidity than organic films. Because the inorganic films formed by oblique vapor deposition have the apertures Y, which are open toward above, the humidity dependence of inorganic films formed by oblique vapor deposition is thought to be caused by the refractive indices of the apertures Y varying due to the entrance and exit of water therein.

The present inventors discovered that the humidity dependence of inorganic films formed by oblique vapor deposition differed greatly depending on the sizes of the apertures Y. As a result, the present inventors arrived at the conclusion that favorable improvements in humidity dependence could be achieved by defining the sizes of the apertures Y.

Water is more likely to enter and exit the apertures of the upper layers of the inorganic films 13A through 13D, that is, humidity dependence is likely to be higher in the upper layers. Accordingly, the present inventors have found that humidity dependence could be effectively improved by defining the defining the sizes of the apertures Y of at least the topmost layer of inorganic film, that is, the inorganic film 13D.

The present inventors have discovered that humidity dependence tends to be improved the greater the sizes of the apertures Y of at least the topmost layer of inorganic film 13D are. Specifically, the present inventors have discovered the favorable improvements in humidity dependence can be obtained by forming the topmost layer of inorganic film 13D such that the mean cross sectional area of the apertures Y is 10 nm² or greater, and preferably 20 nm² or greater. The present inventors infer that the reason for this is as follows.

The inorganic films M1 and M2 illustrated in FIGS. 4A and 4B have the same percentage of apertures (50%, for example). However, the inorganic film M1 is a film having relatively large columnar structures X and apertures Y, whereas the inorganic film M2 is a film having relatively small columnar structures X and apertures Y.

As illustrated in FIG. 4B, water H is likely to be suctioned into the apertures Y of the inorganic film M2, due to capillary action of the smaller apertures Y. In addition, it is thought that the smaller apertures Y will become occluded by small amounts of water H. If the apertures Y become occluded by water H or in a state of near occlusion, the difference in refractive indices of the columnar structures X and the apertures Y decreases, thereby the birefringent properties (retardation value Re) also decrease.

In contrast, as illustrated in FIG. 4A, water H is not as likely to be suctioned into the larger apertures Y of the inorganic film M1, because the capillary action thereof is small. In addition, there will be space left in the larger apertures Y even if the same amount of water H that would occlude the smaller apertures Y is adsorbed therein, and will not become occluded. It is considered that by this film structure, changes in the refractive indices of the apertures Y due to adsorption of water H can be suppressed, thereby suppressing changes in the birefringent properties (retardation value Re) as well.

Generally, materials behave differently when adsorbed into fine apertures according to the diameters thereof. The inner walls of micro apertures (generally defined as those having diameters of 2.0 μm or less) are close to each other, and therefore the van der Waals potentials of the inner walls overlap. The force exerted on materials which are adsorbed by micro apertures is grater than those of mezzo apertures and macro apertures. There is a tendency for micro apertures to adsorb large amounts of materials even under low saturated vapor pressure.

Taking the above into consideration, the present inventors believe that by forming the topmost layer of organic film 13D such that mean cross sectional area of the apertures Y therein are 10 nm² or greater, and preferably 20 nm² or greater, adsorption of water by van der Waals potential can be suppressed. The size of water molecules is approximately 0.3 nm. Accordingly, the present inventors believe that sufficient space will remain in the apertures Y if the mean cross sectional areas thereof are 10 nm² or greater, and preferably 20 nm² or greater, even if several layers of water molecules are adsorbed onto the inner walls of the apertures Y.

The present inventors have discovered that it is possible to realize a birefringent element 1 in which the reduction rate of the retardation value is 30% or less, when the birefringent element 1 is left static in an environment with a temperature of 60° C. and a relative humidity of 90% for three days, by satisfying the aforementioned conditions. The present inventors have also discovered that it is possible to realize a birefringent element 1 in which the reduction rate of the retardation value is 10% or less under the same conditions.

As the apertures Y become larger, the humidity dependence is improved further. However, if the apertures Y become excessively large, it becomes difficult to grow the columnar structures X uniformly, and to obtain a uniform film structure. In addition, interior haze also tends to increase if the apertures Y become excessively large.

The present inventors have discovered that a film having favorable optical properties, such as birefringent properties, transmissivity, and haze value, can be formed stably by forming at least the topmost layer of inorganic film 13D such that the mean cross sectional area of the apertures Y therein are 7500 nm² or less, and preferably 2000 nm² or less.

Taking the effective improvement of humidity dependence, and optical properties such as birefringent properties, transmissivity, and haze value into consideration, the mean cross sectional area of the apertures Y of at least the topmost layer of inorganic film 13D is set to be within a range of 10-7500 nm², and preferably within a range of 20-2000 nm² in the first embodiment.

In the first embodiment, at least the topmost layer of inorganic film 13D needs to satisfy the above condition. Alternatively, two or more of the inorganic films 13A through 13D may satisfy the above condition.

Inorganic films that satisfy the above condition can be stably formed by adjusting oblique vapor deposition conditions. The oblique vapor deposition conditions are set such that the film does not become overly dense.

(1) The apertures Y tend to be smaller as the deflection angle (angle from a line normal to a surface) of the direction of oblique vapor deposition (direction of vapor source as seen from the surface) approaches that of surface vapor deposition. The deflection angle of the direction of oblique vapor deposition is preferably far from that of surface vapor deposition, and specifically is greater than or equal to 40° and less than 90°. When taking the efficient generation of structural refractive indices of the columnar structures X into consideration, it is preferable for the deflection angle of the direction of oblique vapor deposition to be large, and specifically greater than or equal to 50°, and may be greater than or equal to 60°. In cases that the deflection angle of the direction of oblique vapor deposition is close to 90°, the film forming sped is slow and productivity deteriorates. Therefore, a deflection angle of the direction of oblique vapor deposition less than 85°, and particularly less than 80° is preferable if the film forming speed is taken into consideration.

(2) Films tend to be dense the higher the degree of vacuum of the film forming atmosphere is. It is preferable for the degree of vacuum to be greater than or equal to 0.001 Pa, and particularly 0.01 Pa or greater. Meanwhile, if the degree of vacuum is too low, it becomes difficult to uniformly grow the columnar structures X, and interior haze increases. Therefore, it is preferred for the degree of vacuum in the film forming environment to be within a range of 0.01 Pa to 0.1 Pa.

(3) Films tend to be dense the higher the temperature of the base material on which they are formed is. It is preferable for the temperature of the base material to be 200° C. or less, more preferably 100° C. or less, and particularly preferable for the base material to not undergo a heating process.

In the first embodiment, at least one of the three conditions above needs to be satisfied.

The inorganic films may be formed by oblique vapor deposition while monitoring the film thickness d with a crystal film thickness monitor or the like. In addition, the inorganic films may be formed by oblique vapor deposition while measuring the birefringence Δn thereof with an ellipsometer or the like. By performing the aforementioned monitoring and measurement, inorganic films having desired retardation values Re can be formed stably by oblique vapor deposition.

The materials that constitute the inorganic films 13A through 13D are not particularly limited, as long as they are dielectric materials. Taking ease of oblique vapor deposition, light transmissivity, and refractive index into consideration, suitable materials are oxides, nitrides, or oxynitrides of metals such as Ti, Si, Zr, and Ta. These materials have comparatively high refractive indices. Therefore, the films having the same retardation value Re can be formed with thinner film thicknesses when compared against those formed by materials having comparatively low refractive indices, which is favorable from the viewpoint of light transmissivity. By employing the aforementioned materials, a birefringence element 1 having transmissivity with respect to the light L2 that enters the birefringence element 1 of 75% or greater, preferably 80% or greater, and interior haze of 1% or less, preferably 0.7% or less, can be provided stably. If the transmissivity and the haze value satisfy the above conditions, the quality of the brightness and contrast in the liquid crystal device 80 becomes favorable.

The inorganic films 13A through 13D may all be formed by the same material, or be formed by different materials. In addition, each of the inorganic films 13A through 13D may be formed by combinations of two or more of the aforementioned materials.

The inorganic films 13A through 13D may or may not be crystalline. The present inventors have discovered that inorganic films formed by oblique vapor deposition with TiO₂ and/or ZrO₂ as materials having crystalline structures exhibit greater humidity dependence, whereas films formed of the same materials having amorphous structures exhibited less humidity dependence, when the sizes of the apertures Y are equal.

TiO₂ and ZrO₂ are both known to be photocatalysts. When these materials are formed into films having crystalline structures, their photocatalytic properties are enhanced, and they exhibit (ultra) hydrophilic properties. Films that exhibit (ultra) hydrophilic properties are highly hygroscopic, and therefore it is considered that these films exhibit greater humidity dependence. Films having amorphous structures that exhibit less photocatalytic properties and therefore low hydrophilic properties are considered to exhibit less humidity dependence.

It is uncertain whether the above correlation between the crystalline structure and humidity dependence applies to all materials, or whether the humidity dependence is correlated to the (ultra) hydrophilic properties of photocatalysts. In any case, taking the improvement of humidity dependence into consideration, it is preferable for the inorganic film 13D to have an amorphous structure in the case that at least the topmost layer of inorganic film 13D is formed by TiO₂ and/or ZrO₂. Whether the inorganic film 13D has an amorphous structure can be judged by X-ray powder diffraction measurement.

It is preferable for the directions of oblique vapor deposition for each of the four inorganic films that constitute the second phase contrast correcting layer 13 to be different. The phrase “directions of oblique vapor deposition . . . are different” means that the angles of orientation and/or the deflection angles of the direction of oblique deposition (the direction of a vapor deposition source when viewed from a surface) are different.

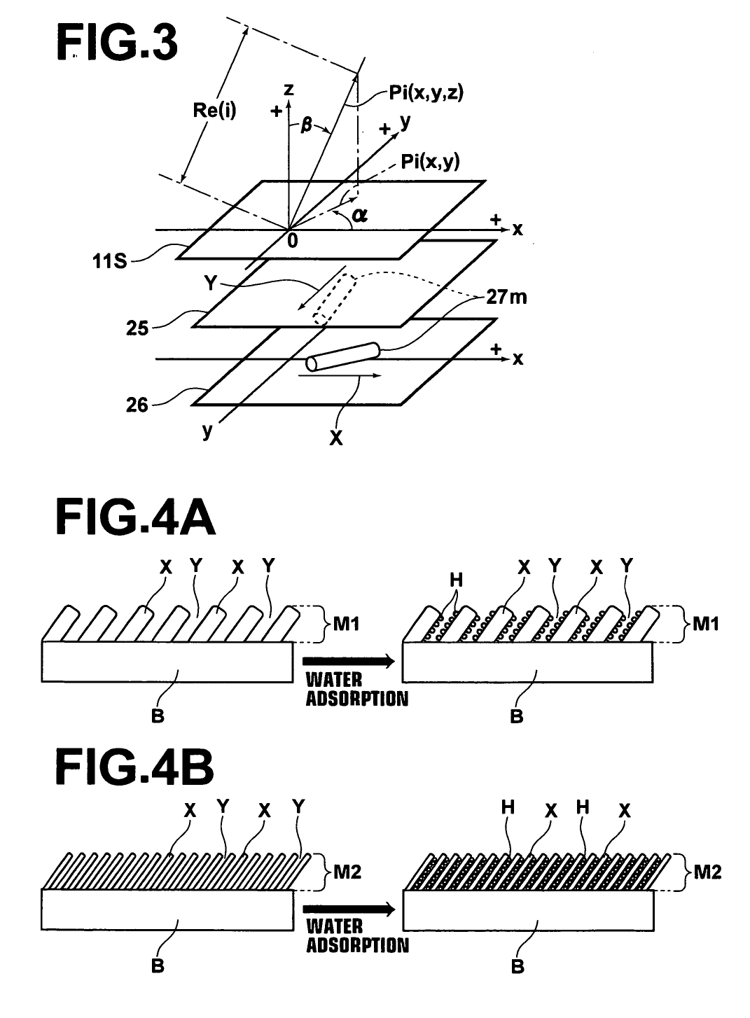

The optical axes of the inorganic films 13A through 13D (the optical axes of the columnar structures X) will be described in detail with reference to FIG. 3. FIG. 3 also illustrates the orienting axes of the orienting films 25 and 26 (the order in which the films are provided is changed as appropriate for the description).

FIG. 3 illustrates the optical axis vector Pᵢ (x, y, z) of an i^{th} (1≦i≦4) inorganic film formed by oblique vapor deposition. The surface of the light transmissive base material 11 on which the inorganic films are formed is denoted by reference numeral 11S. The orienting axis of the orienting film 26, which is positioned closer to the birefringence element 1, is labeled as the x axis, the axis perpendicular to the x axis within the plane of the orienting film 26 is labeled as the y axis, and the axis perpendicular to the plane of the orienting film 26 is labeled as the z axis. The +directions are indicated for each of the x, y, and z axes. Note that the origin, the x axis, the y axis, the z axis, and the have been arbitrarily determined for the sake of convenience in the description, and that reference points may be set as appropriate. The orienting axis of the orienting film 26 is denoted by X, and the orienting axis of the orienting film 25 is denoted by Y.

The optical axis of the i^{th} inorganic film formed by oblique vapor deposition is specified by an angle of orientation α formed by a vector Pᵢ (x, y) in the xy direction and the x axis, and a deflection angle β formed by a vector Pᵢ (x, y, z) and the z axis. In FIG. 3, the angle of orientation α is positive in the counterclockwise direction.

It is preferable for the angles of orientation and/or the deflection angles of the direction of oblique deposition for each of the four inorganic films 13A through 13D to be different. This is because phase contrast correcting functions with respect to the birefringent properties of the liquid crystal molecules 27m in hybrid orientations become favorable with the above configuration.

The directions of oblique vapor deposition for each of the four inorganic films 13A through 13D are not particularly limited. However, it is preferred for the directions of oblique vapor deposition to satisfy the following conditions, in order to provide favorable phase contrast correcting functions with respect to the birefringent properties of the liquid crystal molecules 27m in hybrid orientations.

It is preferable for the vector Pᵢ (x, y) in the xy direction of each of the inorganic films 13A through 13D to not match the x axis, that is, the orienting axis X of the orienting film 26 of the liquid crystal cell 20, which is closer to the birefringence element 1.

Further, it is preferable for xy components (Ax, Ay) of a synthesized vector (ΣPᵢ) of the optical axis vectors of the inorganic films 13A through 13D to satisfy the following inequalities (iii). The xy components are derived by calculating the optical axis vectors Pᵢ (x, y, z) of the inorganic films 13A through 13D according to formula (ii) below, and then obtaining the synthesized vector (ΣPᵢ) therefrom. The synthesized vector (ΣPᵢ) corresponds to an average optical axis vector of the plurality of inorganic films 13A through 13D.
Pᵢ(x,y,z)=(Re(i)×cos αᵢ×sin βᵢ,Re(i)×sin αᵢ×sin βᵢ,Re(i)×cos βᵢ) (ii)
0 nm≦|Ax|≦100 nm, 50 nm≦|Ay|≦200 nm (iii)

(Anti-Reflection Layer)

The anti-reflection layers 14 and 15 prevent reflection at the surfaces of the birefringence element 1, to improve the utilization efficiency of light thereby.

The materials and structure of the anti-reflection layers 14 and 15 are not particularly limited. Examples of constitutions of the anti reflection layers 14 and 15 are: a single layer film formed by MgF₂, which has a low refractive index, at an optical film thickness of λ/4; and a multiple layer film, such as a triple layer film formed by an SiO₂ film at an optical film thickness of λ/4, a TiO₂ film at an optical film thickness of λ/2, and another SiO₂ film at an optical film thickness of λ/4. The anti-reflection layers 14 and 15 may have the same layer structure or different layer structures. λ is the reference wavelength of the light L2 that enters the birefringence element.

The birefringence element 1 and the liquid crystal device 40 of the first embodiment are configured as described above.

In the birefringence element 1 of the first embodiment, the mean cross sectional area of the apertures of at least the topmost layer of the at least one layer of inorganic dielectric film is regulated to be within a range of 10 to 7500 nm².

According to the first embodiment having the above configuration, the inorganic birefringence element 1, which has favorable optical properties such as birefringent properties, transmissivity, and haze value, and that enables improvement of humidity dependence, can be provided at low cost without increasing the number of manufacturing steps.

According to the first embodiment, the inorganic birefringence element 1 can be realized, in which the reduction rate of the retardation value is 30% or less, when left static in an environment with a temperature of 60° C. and a relative humidity of 90% for three days. It is also possible to realize the inorganic birefringence element 1 such that the reduction rate of the retardation value is 10% or less under the same conditions.

The birefringence element 1 of the first embodiment is an inorganic birefringence element. Therefore, it has superior heat resistance properties, light resistance properties, and chemical stability, and is favorable for use in liquid crystal devices which are mounted in projection type display apparatuses, such as projectors.

The liquid crystal device 40 equipped with the birefringence element 1 according to the first embodiment favorably corrects phase contrast, exhibits superior display qualities such as contrast and angular field of view, and can be utilized stably over a long period of time, even under the conditions of use for projection type display apparatuses.

### Second Embodiment

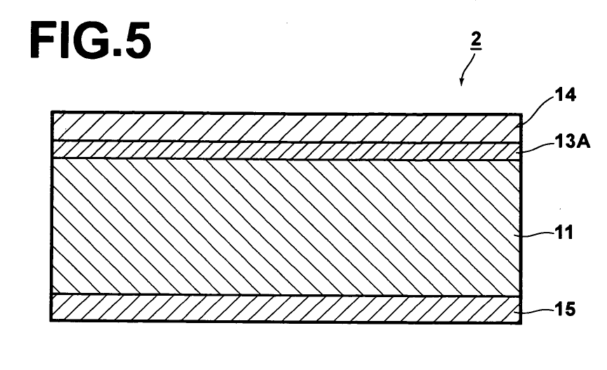

A birefringence element 2 according to a second embodiment of the present invention will be described with reference to FIG. 5. Note that structural elements of the birefringence element 2 which are the same as those of the birefringence element 1 will be denoted with the same reference numerals, and detailed descriptions thereof will be omitted.

As illustrated in FIG. 5, the birefringence element 2 of the second embodiment does not include the first phase contrast correcting layer 12, for performing phase contrast correction with respect to the birefringence of liquid crystal molecules in a substantially uniaxial orientation. The birefringence element 2 comprises a single layer second phase contrast correcting layer 13 constituted by an inorganic film 13A, formed on the light incident surface of a light transmissive base material 11 by oblique vapor deposition. The second phase contrast correcting layer 13 performs phase contrast correction with respect to the birefringence of liquid crystal molecules in hybrid orientations.

As in the first embodiment, anti reflection layers 14 and 15 are formed on the surface of the second phase contrast correcting layer 13 and the light emitting surface of the light transmissive base material, respectively. That is, the anti reflection layers 14 and 15 are formed on the outermost surfaces of the light incident side and the light emitting side of the birefringence element 1, respectively.

In the birefringence element 2 of the second embodiment, there is only a single layer of inorganic film 13A. Therefore, the inorganic film 13A becomes the topmost layer of inorganic film. In the second embodiment, the same effects as those obtained by the first embodiment can be obtained, by setting the mean cross sectional area of apertures Y of the inorganic film 13A to be within a range of 10 to 7500 nm², and preferably within a range of 20 to 2000 nm².

[Design Variations]

The present invention is not limited to the embodiments described above. Various changes and modifications are possible as long as they do not stray from the spirit and scope of the invention.

The birefringence element of the present invention may be of a configuration in which a plurality of the birefringence element 1 of the first embodiment and/or the birefringence element 2 of the second embodiment are stacked atop each other. In this case, the anti-reflection layers may be formed at least on the outermost surfaces of the light incident side and the light emitting side of the plurality of the birefringence element 1 and/or the birefringence element 2, respectively.

A case has been described in which the birefringence element is provided only on the light emitting side of the liquid crystal cell. Alternatively, the birefringence element may be provided on the light incident side and/or the light emitting side of the liquid crystal cell in transmissive liquid crystal devices.

An example has been described in which the liquid crystal device is a normally white TN mode liquid crystal device. Alternatively, the birefringence element of the present invention may be utilized in other types of liquid crystal devices, such as those of the VAN (Vertical Aligned Nematic) mode and those of the LCOS (Liquid Crystal On Silicon) type.

A case has been described in which the liquid crystal device is that which is to be mounted in a projection type display apparatus. Alternatively, the birefringence element of the present invention may be utilized in a liquid crystal device which is to be used as a stand alone display. The birefringence element of the present invention may also be used for applications other than liquid crystal devices.

[Projection Type Display Apparatus]

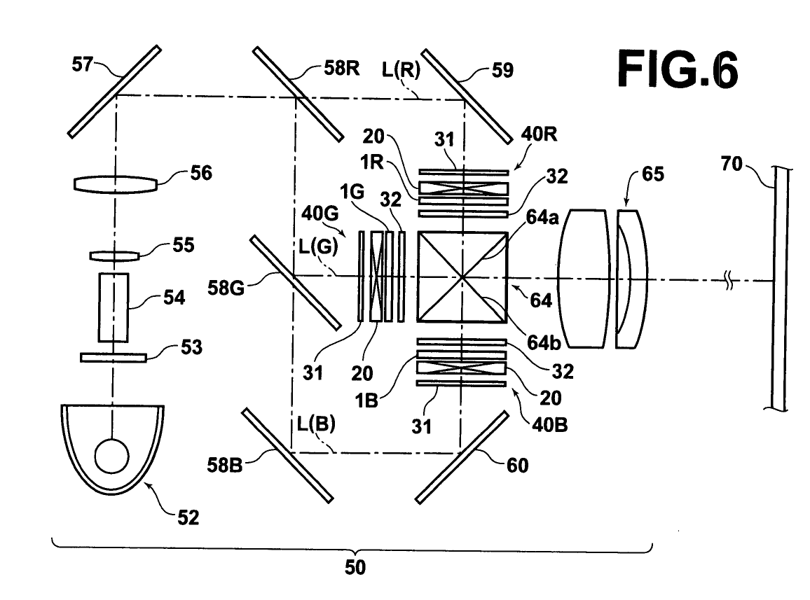

A projection type display apparatus 50 according to an embodiment of the present invention will be described with reference to FIG. 6. The projection type display apparatus 50 is a full color display apparatus equipped with liquid crystal devices (light modulating devices) 40R, 40G, and 40B for modulating red light L(R), green light L(G), and blue light L(B), respectively. The projection type display apparatus 50 is a projector.

The liquid crystal devices 40R, 40G, and 40B are the liquid crystal device 40 of the first embodiment, and comprise birefringence elements 1R, 1G, and 1B, which are the birefringence element 1 of the first embodiment, respectively. The birefringence elements 1R, 1G, and 1B may have the same optical properties. However, the retardation value Re(LC) of the liquid crystal layer 27 varies according to the wavelength of incident light. Therefore, birefringence elements 1R, 1G, and 1B, in which the phase contrast correcting functions have been optimized for the reference wavelength of the color of light to be modulated, may be used.

The structural elements of the liquid crystal devices 40R, 40G, and 40B other than the birefringence elements 1R, 1G, and 1B are the same.

The projection type display apparatus 50 of the present embodiment comprises: a single light source 52; a color dividing optical system for dividing the light emitted from the light source 52 into red light L(R), green light L(G), and blue light L(B); three liquid crystal devices (light modulating devices) 40R, 40G, and 40B, for modulating the red light L(R), the green light L(G), and the blue light L(B), respectively; a single synthesizing prism 64 (synthesizing optical system) for synthesizing the light modulated by the liquid crystal devices 40R, 40G, and 40B; and a projecting lens 65 (projecting optical system), for projecting the light synthesized by the synthesizing prism.

The light source 52 is constituted by a high pressure mercury lamp, an LED, a laser, or the like. A cutoff filter 53, for cutting out unnecessary ultraviolet light and infra red light from the light emitted by the light source 52; an integrator 54 (a rod lens or the like), for homogenizing the white light that passes through the cutoff filter 53; a relay lens 55; a collimating lens 56, for collimating the light that passes through the integrator 54; and a mirror 57, for reflecting the light that passes through the collimating lens 56 toward the color dividing optical system are provided between the light source 52 and the color dividing optical system.

The color dividing optical system comprises: dichroic mirrors 58R and 58G; and mirrors 58B and 60.

The white light reflected by the mirror 57 enters the dichroic mirror 58R, which selectively transmits red light and reflects light of other wavelengths, and is divided thereby. The red light L(R), which has been divided from the white light by the dichroic mirror 58R, enters the liquid crystal device 40R and is modulated according to image signals. The light reflected by the dichroic mirror 58R enters the dichroic mirror 58G, which selectively reflects green light and transmits light of other wavelengths, and is divided thereby. The green light L(G), which has been divided by the dichroic mirror 58G, enters the liquid crystal device 40G and is modulated according to image signals. The blue light L(G), which has been transmitted through the dichroic mirror 58G is reflected by the mirrors 58B and 60, enters the liquid crystal device 40B, and is modulated according to image signals.

The red light L(R), the green light L(G), and the blue light L (B), which have been respectively modulated by the liquid crystal devices 40R, 40G, and 40B, enter the single synthesizing prism 64 (synthesizing optical system). The synthesizing prism 64 has two dichroic surfaces 64a and 64b in the interior thereof. The synthesizing prism 64 synthesizes the red light L(R), the green light L(G), and the blue light L(B), which have been modulated by the liquid crystal devices 40R, 40G, and 40B, and emits the synthesized light unidirectionally. The projection type display apparatus of the present embodiment is used in combination with a screen 70. The synthesized light emitted from the synthesizing prism 64 is enlarged and projected onto the screen via the projecting lens 65 (projecting optical system).

The projection type display apparatus 50 of the present embodiment is configured as described above. The projection type display apparatus 50 utilizes the liquid crystal devices 40R, 40G, and 40B, which are the liquid crystal device 40 of the first embodiment, and therefore has superior humidity dependence properties and optical properties.

A case has been described in which all of the liquid crystal devices 40R, 40G, and 40B are equipped with the inorganic birefringence element of the present invention. Alternatively, the liquid crystal devices 40R and 40G may employ organic birefringence elements. The blue light L(B), which is close to ultraviolet light, has a far greater influence on birefringence elements than the red light L (R) and the green light L(G). Accordingly, a configuration may be adopted, wherein at least the liquid crystal device 40B for modulating the blue light L(B) employs the inorganic birefringence element of the present invention, which has favorable heat resistance and light resistance.

A case has been described in which the projection type display apparatus is a projector. The present invention may also be applied to rear projection type displays.

### EXAMPLES

An example of the present invention and a comparative example will be described.

### Example 1

A birefringence element for blue light (reference wavelength: 430 nm) was produced by forming a single layer of inorganic film on the surface of a light transmissive base material by oblique vapor deposition, according to the following steps.

A 50×50 mm glass substrate (1737 glass by Corning), which was washed with acetone and sufficiently dried, was employed as the light transmissive base material. The composition of the inorganic film was ZrO₂/TiO₂ compound, with a weight ratio of 90/10.

An electron beam vapor deposition apparatus equipped with a base material jig that enables changing of the angle of orientation and the deflection angles of the direction of oblique deposition was employed. The electron beam vapor deposition apparatus was also equipped with an ellipsometer for measuring the birefringence of the film during formation thereof, and a crystal film thickness monitor for measuring the film thickness of the film during formation thereof. The base material was set such that the angle of orientation of the direction of the vapor deposition source was −137° and the deflection angle was 80°, when viewed from the surface of the base material (the direction of the vapor deposition source is the direction of oblique vapor deposition).

Air was expelled from the interior of the electron beam vapor deposition apparatus until the pressure therein was 0.0001 Pa, and oxygen gas was introduced until the pressure therein was 0.01 Pa. Oblique vapor deposition was performed with this degree of vacuum without heating, and an inorganic film having a retardation value Re of 150 nm (measuring wavelength: 430 nm) was formed on the base material.

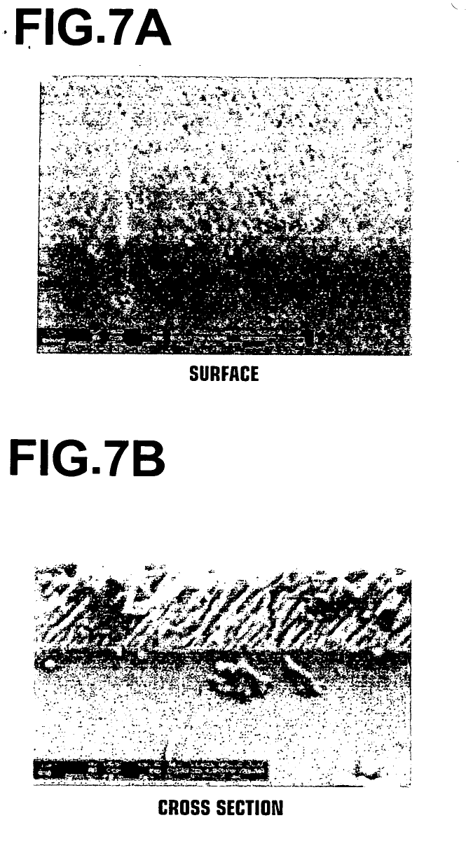

The surface and a cross section of the formed inorganic film were observed with a scanning electron microscope. FIG. 7A is a photograph of the surface of the inorganic film, and FIG. 7B is a photograph of the cross section of the inorganic film.

The inorganic film had a film structure constituted by a great number of columnar structures that extended in a direction inclined with respect to the surface of the base material and a great number of apertures, which were formed between the columnar structures and extended substantially in the same direction as the columnar structures. The apertures were substantially triangular in plan view. The mean cross sectional area of the apertures was approximately 700 nm². The deflection angle β of the optical axes of the columnar structures was 45°. X-ray powder diffraction measurement was performed, and it was found that the inorganic film had an amorphous structure.

The birefringence element thus obtained had a transmissivity of 85% with respect to light having a wavelength of 430 nm, and a haze value of 0.9%.

The birefringence element was left static in an environment with a temperature of 60° C. and a relative humidity of 90%, and the humidity dependence thereof was evaluated. The retardation rate Re, the transmissivity, and the haze value were measured after one hour, one day, and three days. The results are illustrated in Table 1. The birefringence element exhibited humidity dependence, and the retardation value Re did not change significantly from the 150 nm value immediately after production thereof, even when left static in a high temperature high humidity environment. Significant changes were not observed in the transmissivity and the haze value as well.

The birefringence element was mounted on a liquid crystal cell of a liquid crystal projector and the contrast was measured. The contrast value approximately doubled to 1125 from 556, which was the contrast value prior to the mounting of the birefringence element. This value did not change prior to and following the aforementioned humidity dependence evaluation.

### Comparative Example 1

A birefringence element for blue light (reference wavelength: 430 nm) was produced as a comparative example, by forming a single layer of inorganic film on the surface of a light transmissive base material by oblique vapor deposition.

The comparative example was produced in the same manner as the birefringence element of Example 1, except that air was expelled from the interior of the electron beam vapor deposition apparatus until the pressure therein was 0.0001 Pa, then oxygen gas was introduced until the pressure therein was 0.005 Pa, and that the base material was heated to 300° C. within this degree of vacuum prior to oblique vapor deposition being performed.

The surface and a cross section of the formed inorganic film were observed with a scanning electron microscope and a transmission electron microscope.

The inorganic film had a film structure constituted by a great number of columnar structures that extended in a direction inclined with respect to the surface of the base material. The deflection angle β of the optical axes of the columnar structures was 45°. The mean cross sectional area of the apertures was less than or equal to the resolution of the transmission electron microscope (5 nm²).

X-ray powder diffraction measurement was performed, and it was found that the inorganic film had an amorphous structure.

The birefringence element thus obtained had a transmissivity of 83% with respect to light having a wavelength of 430 nm, and a haze value of 0.6%. The humidity dependence of the birefringence element of comparative example 1 was evaluated in the same manner as in Example 1. The birefringence element of comparative example 1 exhibited great humidity dependence, and the retardation value Re decreased significantly from the 150 nm value immediately after production thereof and was reduced to approximately 50%, when left static in the high temperature high humidity environment.

The birefringence element was mounted on a liquid crystal cell of a liquid crystal projector and the contrast was measured. The contrast value approximately doubled to 1055 from 556, which was the contrast value prior to the mounting of the birefringence element. However, the contrast value deteriorated to 751 following the aforementioned humidity dependence evaluation.

TABLE 1

| | | Initial | 60°, 90% RH | | |
|---|---|---|---|---|---|
| | | Values | 1 hour | 1 day | 3 days |
| Example 1 | Re (nm) | 150 | 150 | 149.5 | 149 |
| | Transmissivity | 85 | 85 | 85 | 85 |
| | (%) | | | | |
| | Haze Value (%) | 0.9 | 0.9 | 0.9 | 0.9 |
| Comparative | Re (nm) | 150 | 150 | 120 | 80 |
| Example 1 | Transmissivity | 83 | 83 | 83 | 82 |
| | (%) | | | | |
| | Haze Value (%) | 0.6 | 0.6 | 0.7 | 0.8 |

### INDUSTRIAL APPLICABILITY

The birefringence element of the present invention can be favorably utilized in liquid crystal devices, and particularly those which are mounted in projection type display apparatuses.

What is claimed is:

1. A birefringence element, comprising:
a light transmissive base material; and
at least one layer of inorganic dielectric film formed on the surface of the light transmissive base material by oblique vapor deposition; wherein:
the at least one layer of inorganic dielectric film has a film structure constituted by a great number of columnar structures that extend in a direction inclined with respect to the surface of the light transmissive base material and a great number of apertures, which are formed between the columnar structures and extend substantially in the same direction as the columnar structures; and
the mean cross sectional area of the apertures of at least the topmost layer of the at least one layer of inorganic dielectric film is within a range of 10 to 7500 nm².

2. A birefringence element, comprising:
a light transmissive base material; and
at least one layer of inorganic dielectric film formed on the surface of the light transmissive base material by oblique vapor deposition; wherein:
the reduction rate of a retardation value is 30% or less, when left static in an environment with a temperature of 60° C. and a relative humidity of 90% for three days.

3. A birefringence element as defined in claim 1, wherein:
the inorganic dielectric film is constituted by at least one of: a metal oxide, a metal nitride, and a metal oxynitride; and
the birefringence element has a transmissivity of 75% or greater with respect to a reference frequency of light incident thereto, and a haze value of 1% or less.

4. A birefringence element as defined in claim 2, wherein:
the inorganic dielectric film is constituted by at least one of: a metal oxide, a metal nitride, and a metal oxynitride; and
the birefringence element has a transmissivity of 75% or greater with respect to a reference frequency of light incident thereto, and a haze value of 1% or less.

5. A birefringence element as defined in claim 1, wherein:
at least the topmost layer of the at least one layer of inorganic dielectric film has an amorphous structure.

6. A birefringence element as defined in claim 2, wherein:
at least the topmost layer of the at least one layer of inorganic dielectric film has an amorphous structure.

7. A birefringence element as defined in claim 1, wherein:
the optical axes of the columnar structures that constitute at least the topmost layer of the at least one layer of inorganic dielectric film are inclined with respect to a line normal to the surface of the light transmissive base material at an angle greater than or equal to 0° and less than 50°.

8. A birefringence element as defined in claim 2, wherein:
the optical axes of the columnar structures that constitute at least the topmost layer of the at least one layer of inorganic dielectric film are inclined with respect to a line normal to the surface of the light transmissive base material at an angle greater than or equal to 0° and less than 50°.

9. A birefringence element as defined in claim 1, wherein:
at least the topmost layer of the at least one layer of inorganic dielectric film is formed by oblique vapor deposition within an atmosphere having a degree of vacuum of 0.001 Pa or greater.

10. A birefringence element as defined in claim 2, wherein:
at least the topmost layer of the at least one layer of inorganic dielectric film is formed by oblique vapor deposition within an atmosphere having a degree of vacuum of 0.001 Pa or greater.

11. A birefringence element as defined in claim 1, wherein:
at least the topmost layer of the at least one layer of inorganic dielectric film is formed by oblique vapor deposition with the temperature of the base material being 200° C. or less.

12. A birefringence element as defined in claim 2, wherein:
at least the topmost layer of the at least one layer of inorganic dielectric film is formed by oblique vapor deposition with the temperature of the base material being 200° C. or less.

13. A birefringence element as defined in claim 1, further comprising:
a surface inorganic film formed on the surface of the light transmissive base material by vapor phase deposition.

14. A birefringence element as defined in claim 2, further comprising:
a surface inorganic film formed on the surface of the light transmissive base material by vapor phase deposition.

15. A birefringence element as defined in claim 13, to be employed in combination with a liquid crystal cell, comprising a liquid crystal layer, a pair of substrates which are provided facing each other to sandwich the liquid crystal layer therebetween, and electrodes for applying voltage to the liquid crystal layer, provided on the pair of substrates; wherein:
the surface inorganic film performs phase contrast correction on the birefringent properties of liquid crystal molecules, which are arranged in a substantially uniaxial orientation; and
the at least one layer of the inorganic dielectric film performs phase contrast correction on the birefringent properties of liquid crystal molecules, which are arranged in hybrid orientations.

16. A birefringence element as defined in claim 14, to be employed in combination with a liquid crystal cell, comprising a liquid crystal layer, a pair of substrates which are provided facing each other to sandwich the liquid crystal layer therebetween, and electrodes for applying voltage to the liquid crystal layer, provided on the pair of substrates; wherein:
the surface inorganic film performs phase contrast correction on the birefringent properties of liquid crystal molecules, which are arranged in a substantially uniaxial orientation; and
the at least one layer of the inorganic dielectric film performs phase contrast correction on the birefringent properties of liquid crystal molecules, which are arranged in hybrid orientations.

17. A birefringence element as defined in claim 1, further comprising:
an anti-reflection layer provided on the outermost surface of at least one of a light incident side and a light emitting side.

18. A birefringence element as defined in claim 2, further comprising:
an anti-reflection layer provided on the outermost surface of at least one of a light incident side and a light emitting side.

19. A method for manufacturing the birefringence element defined in claim 1, wherein:
at least the topmost layer of the at least one layer of inorganic dielectric film is formed by oblique vapor deposition, with the oblique vapor deposition direction being inclined at an angle greater than or equal to 40° and less than 90° with respect to a line normal to the surface of the light transmissive base material, on which the film is formed.

20. A method for manufacturing the birefringence element defined in claim 2, wherein:
at least the topmost layer of the at least one layer of inorganic dielectric film is formed by oblique vapor deposition, with the oblique vapor deposition direction being inclined at an angle greater than or equal to 40° and less than 90° with respect to a line normal to the surface of the light transmissive base material, on which the film is formed.

21. A method for manufacturing the birefringence element defined in claim 1, wherein:
at least the topmost layer of the at least one layer of inorganic dielectric film is formed by oblique vapor deposition within an atmosphere having a degree of vacuum of 0.001 Pa or greater.

22. A method for manufacturing the birefringence element defined in claim 2, wherein:
at least the topmost layer of the at least one layer of inorganic dielectric film is formed by oblique vapor deposition within an atmosphere having a degree of vacuum of 0.001 Pa or greater.

23. A method for manufacturing the birefringence element defined in claim 1, wherein:
at least the topmost layer of the at least one layer of inorganic dielectric film is formed by oblique vapor deposition with the temperature of the base material being 200° C. or less.

24. A method for manufacturing the birefringence element defined in claim 2, wherein:
at least the topmost layer of the at least one layer of inorganic dielectric film is formed by oblique vapor deposition with the temperature of the base material being 200° C. or less.

25. A liquid crystal device, comprising:
a liquid crystal cell comprising:
a liquid crystal layer;
a pair of substrates which are provided facing each other to sandwich the liquid crystal layer therebetween;
orienting films for defining the orientation of liquid crystal molecules within the liquid crystal layers when voltage is not applied thereto, formed on the pair of substrates; and
electrodes for applying voltage to the liquid crystal layer, provided on the pair of substrates; and
the birefringence element as defined in claim 1, provided facing the liquid crystal cell.

26. A liquid crystal device, comprising:
a liquid crystal cell comprising:
a liquid crystal layer;
a pair of substrates which are provided facing each other to sandwich the liquid crystal layer therebetween;
orienting films for defining the orientation of liquid crystal molecules within the liquid crystal layers when voltage is not applied thereto, formed on the pair of substrates; and
electrodes for applying voltage to the liquid crystal layer, provided on the pair of substrates; and
the birefringence element defined in claim 2, provided facing the liquid crystal cell.

27. A projection type display apparatus, comprising:
a light source;
a light modulating apparatus comprising the liquid crystal device defined in claim 25, for modulating light emitted by the light source; and
a projecting optical system, for projecting the light modulated by the light modulating apparatus.

28. A projection type display apparatus, comprising:
a light source;
a light modulating apparatus comprising the liquid crystal device defined in claim 26, for modulating light emitted by the light source; and
a projecting optical system, for projecting the light modulated by the light modulating apparatus.
